(19) United States
(12) Patent Application Publication
(10) Pub. No.: US 2009/0171905 A1
(43) Pub. Date: Jul. 2, 2009

(54) PRODUCING INFORMATION DISCLOSURE STATEMENTS

(76) Inventor: Edouard Garcia, Menlo Park, CA (US)

Correspondence Address: EDOUARD GARCIA;Attorney At Law, 1351 Cuernavaca Circulo, Mountain View, CA, 94040, US

(21) Appl. No.: 11/968,298

(22) Filed: Jan. 2, 2008

(51) Int. Cl. G06F 17/30; G06F 7/00

(52) U.S. Cl. 707/3; 707/10; 707/E17.108; 707/E17.001

(57) ABSTRACT

An information disclosure statement (IDS) request is unpacked. The IDS request includes information that identifies one or more references. For each of the references, a respective bibliographic record is built from the information in the IDS request. Incomplete ones of the bibliographic records are determined. For each of the bibliographic records determined to be incomplete, information needed to complete the bibliographic record are searched and the bibliographic record is completed in response to a successful search. An electronic IDS is produced from one or more of the bibliographic records.

### BACKGROUND

Under the rules of the United States Patent and Trademark Office (USPTO), applicants and others involved in the preparation or prosecution of a patent application have a duty to disclose to the USPTO all information known to be material to patentability. This duty oftentimes is satisfied by submitting to the USPTO an information disclosure statement (IDS) that contains a list of citations to all the references known to be material to patentability, along with copies of certain ones of the cited references. The process of preparing IDSs typically is tedious, time-consuming, laborious, and prone to human error.

### SUMMARY

In one aspect, the invention features a method in accordance with which an information disclosure statement (IDS) request is unpacked. The IDS request includes information that identifies one or more references. For each of the references, a respective bibliographic record is built from the information in the IDS request. Incomplete ones of the bibliographic records are determined. For each of the bibliographic records determined to be incomplete, the method involves searching for information needed to complete the bibliographic record and completing the bibliographic record in response to a successful search. An electronic IDS is produced from one or more of the bibliographic records.

Other features and advantages of the invention will become apparent from the following description, including the drawings and the claims.

### DESCRIPTION OF DRAWINGS

FIG. 1 is a diagrammatic view of an embodiment of an IDS server node that includes an IDS manager and is connected to a client node and multiple search engines by a wide area network.

FIG. 2 is a flow diagram of an embodiment of a method of producing an information disclosure statement.

FIG. 3 is a diagrammatic view of an embodiment of a graphical user interface that is generated by the IDS manager shown in FIG. 1.

FIG. 4 is a diagrammatic view of an embodiment of a graphical user interface that is generated by the IDS manager shown in FIG. 1.

FIG. 5 is a flow diagram of an embodiment of a method of producing an information disclosure statement.

FIG. 6 is a diagrammatic view of an embodiment of a computer system that is programmed to implement the IDS manager shown in FIG. 1.

FIG. 7 shows data flow through an embodiment of the IDS manager shown in FIG. 1.

FIG. 8 is a diagrammatic view of an embodiment of the wide area network shown in FIG. 1 that connects the IDS server node to a remote service provider node.

FIG. 9 is a flow diagram of an embodiment of a method of producing an information disclosure statement.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Overview

The embodiments that are described herein provide systems and methods of producing information disclosure statements (IDSs). These embodiments are designed to alleviate the tedious, time-consuming, laborious, and error-prone task of manually preparing such IDSs. In addition, these embodiments are capable of automatically handling the retrieval of missing citation metadata, alleviating the substantial burden that oftentimes is associated with manual retrieval of such information.

### II. Definitions of Terms

An “information disclosure statement” (IDS) is a collection of one or more documents that can be submitted to a patent office in connection with a pending patent application, where the one or more documents typically describe or identify information relating to the subject matter being claimed in the patent application. The collection typically includes a citation document that contains a list of citations to one or more references. The collection may include copies of one or more of the references listed in the citation document.

A “reference” is a document that is citatable in an IDS. Exemplary types of references include US patent publications, non-US patent publications, and non-patent literature (e.g., books and journal articles).

A “bibliographic record” is a record that includes citation metadata for a particular reference.

“Citation metadata” is metadata that can be used in identifying a reference. Exemplary types of citation metadata include patent number, publication number, author, book title, place of book publication, book publisher, publication date, journal name, journal volume, journal issue, and page number(s).

The verb “unpack” means to separate and analyze the contents of:

A “node” is a junction or connection point in a network. Exemplary nodes include, but not limited to, a terminal, a computer, and a network switch.

A “third party” refers to an entity that is not affiliated with the entity that owns or controls the IDS manager 12. A third party typically is independent of any contract between the user of the web browser 18 and the owner of the IDS manager 12.

A “computer” is a machine that processes data according to machine-readable instructions (e.g., software) that are stored on a machine-readable medium either temporarily or permanently. A set of such instructions that performs a particular task is referred to as a program or software program.

The term “machine-readable medium” refers to any medium capable carrying information that is readable by a machine (e.g., a computer). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM

An “input box” is an element of a graphical user interface that allows a user to input information to be used by a computer program. An exemplary input box is rectangular and includes a border that separates the input box from the rest of the graphical user interface.

### III. Introduction

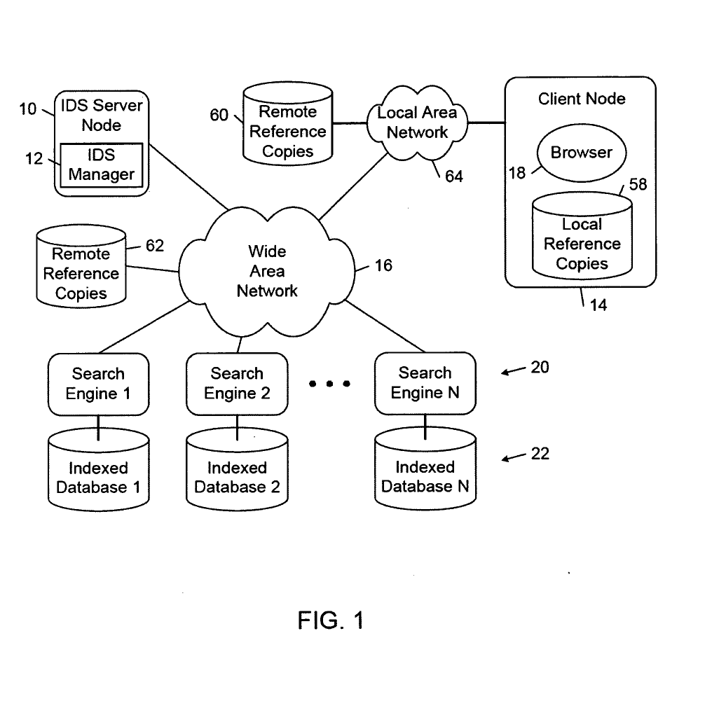

FIG. 1 shows an embodiment of an IDS server node 10 that includes an embodiment of an IDS manager 12 that produces an IDS in response to an IDS request that is received from a client node 14. As explained in detail below, the IDS manager 12 builds a bibliographic record for each of one or more references that are identified in the IDS request, searches external sources for information needed to complete any of the bibliographic records that are missing any required citation metadata, and produces an electronic IDS from the bibliographic records. The IDS manager 12 is capable of automatically preparing an IDS that contains complete citations to references that are required to be cited in satisfaction of the duty of disclosure imposed by the rules of the USPTO. In this way, the IDS manager 12 alleviates the tedious, time-consuming, laborious, and error-prone task of manually preparing such an IDS. In addition, the IDS manager 12 automatically handles the retrieval of missing citation metadata, alleviating the substantial burden that oftentimes is associated with manual retrieval of such information.

The IDS manager 12 communicates with the client node 14 over a wide area network 16 (e.g., the internet) via a graphical user interface that is accessed by a web browser 18 running on the client node 14. The wide area network 16 may include a number of different computing platforms and transport facilities, including a voice network, a wireless network, and a computer network (e.g., the internet). IDS requests from the web browser 18 and electronic IDSs from the IDS manager 12 may be transmitted in a number of different media formats, such as voice, internet, e-mail and wireless formats. In this way, users may access the services provided by the IDS manager 12 using any one of a wide variety of different communication devices, such as a personal computer and a wireless device (e.g., a wireless personal digital assistant (PDA) or cellular telephone).

In some embodiments, the IDS manager 12 submits queries to one or more web search engines 20 in an effort to determine information that is needed to complete any of the bibliographic records that are missing any required citation metadata. The web search engines 20 respond to queries that are received from the IDS manager 12 by querying respective databases 22 that contain indexed references to web pages and other documents that are accessible over the wide area network 16. The queries may be atomic or in the form of a continuous query that includes a stream of input data. The response to (or results of) continuous queries likewise may be presented in the form of a data stream. Some of the web search engines 20 provide specialized search services that are narrowly tailored for specific informational domains. For example, the MapPoint® Web service provides location-based services such as maps, driving directions, and proximity searches, the Delphion™ Web service, the freepatentsonline Web service, and the USPTO Web service provide patent search services, the Bibme Web service (see http://www.bibme.org/) provides bibliographic information retrieval services, the BigYellow™ Web service provides business, products and service search services, the Tucows Web services provides software search services, the CareerBuilder.com™ Web service provides jobs search services, and the MusicSearch.com™ Web service provides music search services. Other ones of the web search engines 20, such as Google™, Yahoo™, AltaVista™, Lycos™, and Excite™, provide search services that are not limited to specific informational domains. Still other ones of the web search engines 20 are meta-search engines that perform searches using other search engines. The web search engines 20 may provide access to their search services free-of-charge or in exchange for a fee.

The IDS request typically contains all the information that is needed by the IDS manager 12 to directly or indirectly determine all the citation metadata that is needed to complete the bibliographic record for each of the references to be cited in the electronic IDS. In some cases, the IDS request contains all the citation metadata that is required to complete the electronic IDS. In other cases, the IDS request contains less than all of the required citation metadata. In these cases, however, the IDS request typically contains information that is sufficient for the IDS manager 12 to determine all of the required citation metadata. For example, the IDS request may contain for a particular reference only part of the required citation metadata, but this information can be used by the IDS manager 12 to search for the missing citation metadata (e.g., by querying one or more local or remote databases). In another example, the IDS request may contain information (e.g., a pointer, such as a URL or URI) that can be used by the IDS manager 12 to access a document, such as a web page, that contains some or all of the citation metadata required for a complete citation to a reference of particular type. In some cases, the IDS request includes a reference to be cited and the IDS manager 12 is able to extract from the reference information that can be used by the IDS manager 12 to directly or indirectly determine the citation metadata required for a complete citation to that reference.

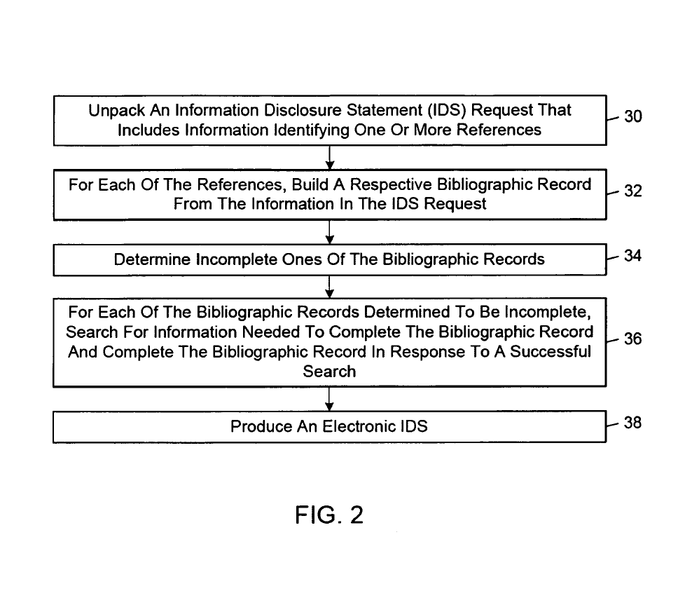

FIG. 2 shows an embodiment of a method that is implemented by embodiments of the IDS manager 12.

In accordance with this embodiment, the IDS manager 12 unpacks an IDS request that includes information identifying one or more references (FIG. 2, block 30). If the IDS request includes text that identifies at least one of the references, the IDS manager 12 may extract, for example, citation metadata or inferential information (e.g., a URL or URI) from which missing citation metadata can be determined from the text contained in the IDS request form. If the IDS request includes a respective one of the references, the IDS manager 12 may, for example, extract from the reference citation metadata (e.g., author, title, etc.) or inferential information (e.g., a URL or URI) from which missing citation metadata can be determined. The reference-identifying information (e.g., the citation metadata and the inferential metadata) may be extracted from metadata embedded (e.g., in a header portion) in the reference. Alternatively, the reference identifying information may be extracted by parsing the reference based on an analysis of metadata field separators (e.g., periods and commas), metadata tags, or both. The IDS manager 12 may use one or more of the following techniques to extract the reference identifying information from the IDS request, the reference itself, or a web page or other resource: machine-learning metadata extraction techniques, template mining based metadata extraction techniques, and knowledge-based metadata extraction techniques. In some embodiments, optical character recognition may be performed on the reference before it is parsed by the IDS manager 12.

For each of the references, the IDS manager 12 builds a respective bibliographic record from the information in the IDS request (FIG. 2, block 32). The bibliographic records typically are arranged in a data structure (e.g., a table or a list), which is stored on a machine-readable medium. In some embodiments, the bibliographic records are stored in an XML (extensible Markup Language) file format. In some embodiments, the bibliographic records are stored in an electronic form (e.g., PTO/SB/08a, available from the USPTO) that corresponds to the electronic IDS that will be sent to the client node 14 in response to the IDS request. Storage devices suitable for tangibly embodying the bibliographic record data structure include all forms of non-volatile computer-readable media and volatile computer-readable media, including but not limited to, for example, semiconductor memory devices, such as EPROM, EEPROM, and flash memory devices, magnetic disks such as internal hard disks and removable disks, magneto-optical disks, and CD-ROMs.

The IDS manager 12 determines incomplete ones of the bibliographic records (FIG. 2, block 34). In some embodiments, this process involves determining a respective reference type of the reference, selecting a respective set of required citation metadata types corresponding to the determined reference type, and determining whether citation metadata was extracted for each of the required citation metadata types. If less than all of the required citation metadata types were extracted for a given bibliographic record, that bibliographic record is designed as an incomplete bibliographic record (e.g., by associating a particular label or flag with the bibliographic record).

For each of the bibliographic records determined to be incomplete, the IDS manager 12 searches for information that is needed to complete the bibliographic record and completes the bibliographic record in response to a successful search (FIG. 2, block 36). In this process, the IDS manager 12 may, for example, retrieve missing citation metadata (i) by submitting search queries to one or more of the search engines 20 and analyzing the search results or (ii) by accessing documents (e.g., web pages) or other resources pointed to by reference-information-identifying links that are extracted from the IDS request.

For each of the incomplete bibliographic records that have some reference-identifying information, the IDS manager 12 generates a citation search query from the bibliographic record, transmits the citation search query to at least one of the search engines 22, and receives a respective search response from the search engine. The IDS manager 12 typically generates a search query for each of the incomplete bibliographic records by extracting one or more search criteria of the citation search from the bibliographic record. In this process, the IDS manager 12 typically obtains from the bibliographic record at least one keyword that is used in the creation of the citation search query. The IDS manager 12 typically translates the citation search query into a native format of each search engine before transmitting the citation search query to the search engine. In response to a successful search, the IDS manager 12 extracts the missing citation metadata from the respective search response received from the search engine and uses the extracted citation metadata to complete the respective bibliographic record.

For each of the incomplete bibliographic records that include a reference-information-identifying link, the IDS manager 12 parses the document or other resource pointed to by the link for citation metadata or other information that identifying the reference associated with the bibliographic record. In this process, the IDS manager 12 may use any of a variety of different bibliographic extraction techniques including, but not limited to, machine-learning metadata extraction techniques, template mining based metadata extraction techniques, and knowledge-based metadata extraction techniques.

The IDS manager 12 produces an electronic IDS (FIG. 2, block 38). In some embodiments, the IDS manager 12 inputs data from complete ones of the bibliographic records into matching fields of an electronic IDS form. The IDS form may be any form that contains fields for all of the information that is required for a complete citation to each of the references. In some exemplary embodiments, the IDS form corresponds to the form PTO/SB/08a, available from the USPTO (http://www.uspto.gov/web/forms/). The resulting electronic IDS contains a complete (or full) citation to each of the references that is associated with a complete bibliographic record. The IDS manager 12 may handle references for which complete bibliographic records could not be built after the initial round of searching (see FIG. 2, block36) in a variety of difference ways. For example, in some embodiments, the IDS manager 12 requests additional information (e.g., the information that is missing from the bibliographic record or information, such as a pointer to a document or other resource, that indirectly can be used to determine the missing information) from the client node 14 or from a remote service provider node. In some embodiments, the IDS manager 12 enters an incomplete citation for the reference into the electronic IDS along with an indication that the citation is incomplete.

### IV. A First Exemplary Embodiment of the IDS Manager

A. User Interface

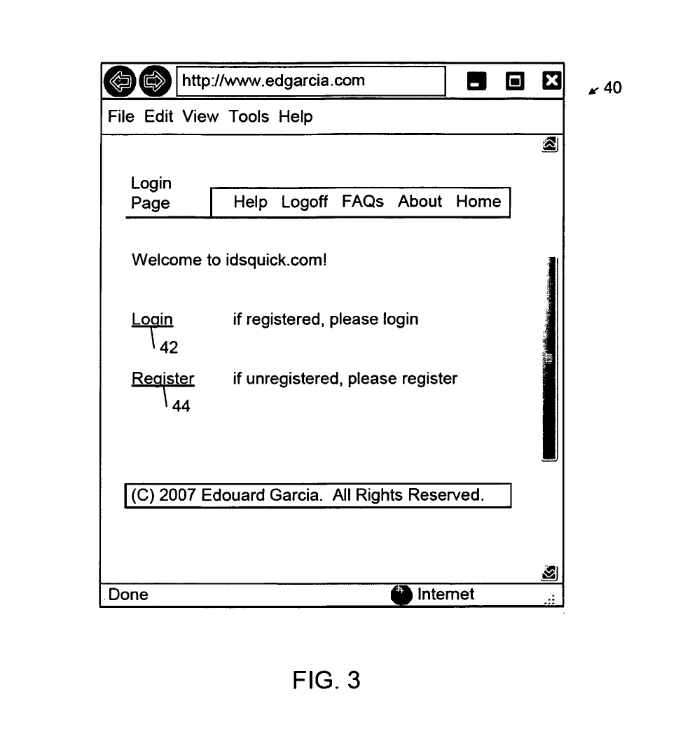

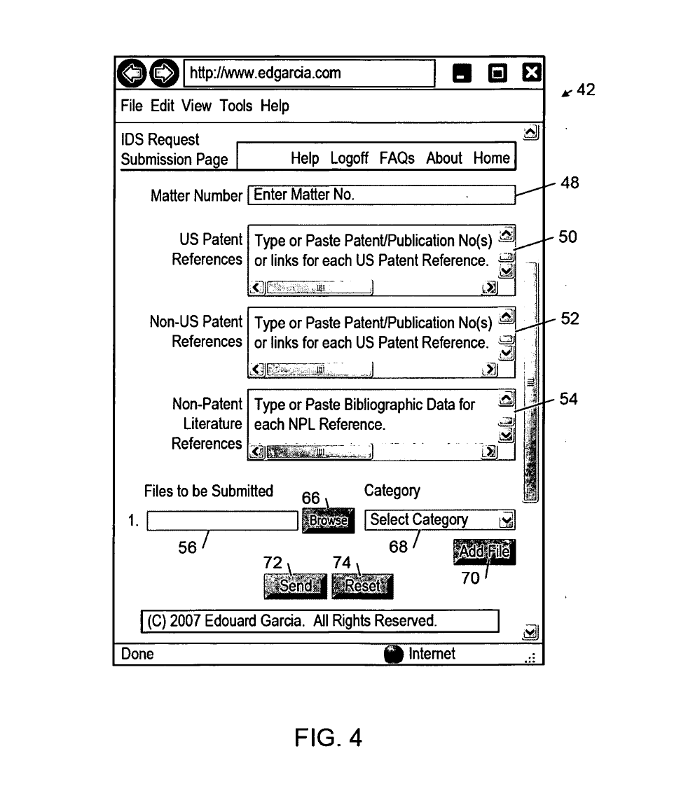

FIGS. 3 and 4 show embodiments of graphical user interfaces 40, 42 through which the IDS manager 12 presents information to and receives information from a user of the web browser 18 executing on the client node 14 (see FIG. 1).

Initially, the user navigates to the graphical user interface 40 (FIG. 3), which presents the user with a login page that contains options for logging into the system or registering the client node 14. In the illustrated embodiment, privacy and reliability are provided by requiring users to register before being permitted to access the services provided by the IDS manager 12. In response to the selection of the Register link 44, the user's browser is directed to a registration page that includes a registration form, which requests information that identifies the user or the entity represented by the user and a password. Upon completion of the registration form, the user is allowed to download to the client node 14 a digital certificate that is associated with the password. The digital certificate typically must be authorized by an administrator that is associated with the IDS manager 12 before the user can log into the system. After successfully being authorized, the user can select the Login link 46 to access the services provided by the IDS manager 12. In response to the selection of the Login link 46, the user's browser is directed to a login page that requests the user to enter the password that is associated with the digital certificate that was downloaded to the client node 14.

After successfully logging into the system, the user's web browser 18 is directed to the graphical user interface 42 (FIG. 4), which presents the user with an IDS request submission page that contains options for preparing an IDS request. The IDS request submission page allows the user to prepare an IDS request by identifying a matter number and the references to be cited in an electronic IDS. The IDS manager 12 processes the IDS request and returns to the user an electronic IDS that cites the identified references. In some embodiments, the IDS manager 12 communicates with the user's web browser 18 using the secure sockets layer (SSL) protocol, which uses the digital certificate when sending information between the IDS server node 10 and the client node 14.

In the illustrated embodiment, the IDS request submission page includes a Matter Number input box 48, a US Patent References input box 50, a Non-US Patent References input box 52, a Non-Patent Literature References input box 54, and a Files to be Submitted input box 56. Each of the input boxes 50-56 is capable of receiving one or more sets of reference identifying information, which each set relates to a single reference and is demarcated by one or more specified set-delimiting characters (e.g., a carriage-returns, tabs, brackets, braces, etc.). In other embodiments, the IDS request submission page presents a respective input box for each set of reference identifying information.

The Matter Number input box 48 is designed to receive a matter number that is used to label the electronic IDS produced by the IDS manager 12. The matter number entered by the user may correspond to an actual docket number (e.g., an attorney docket number or a patent application number) that is used as an internal or external identifier of a patent application, or it may be some other number.

The US Patent References input box 50 is designed to receive a US patent publication number or a link for each US patent reference to be cited in the electronic IDS to be produced by the IDS manager. Each US patent reference may correspond to an issued US patent or a published US patent application. Each US patent publication number may be specified in one or more formats that can be parsed by the IDS manager 12. For example, in some embodiments, each US patent number may be specified in any of the following formats: ______; ______; U.S. Pat. No. ______; U.S. Pat. No. ______; where each “x” represents a placeholder for a respective number. Each US patent application publication number may be specified in any of the following formats: ______; ______; US______; US______; where each “x” represents a placeholder for a respective number. Each link entered into the US Patent References input box 50 typically corresponds to a URL or a URI that identifies a web page or other resource that contains bibliographic information for a respective US patent reference. The IDS manager 12 is capable of extracting citation metadata from the bibliographic information contained in the resource pointed to by the link.

The Non-US Patent References input box 52 is designed to receive a patent number or a link for each non-US patent reference to be cited in the electronic IDS to be produced by the IDS manager. Each non-US patent reference may correspond to an issued non-US patent or a published non-US patent application. Each non-US patent number may be specified in one or more formats that can be parsed by the IDS manager 12. For example, in some embodiments, each non-US patent number may be specified in any of the following formats: a country code followed by a string of numbers; and a country code followed by multiple number strings segmented by commas or other breaks (e.g., commas, backslashes, spaces, etc.). Each link entered into the non-US Patent References input box 52 typically corresponds to a URL or a URI that identifies a web page or other resource that contains bibliographic information for a respective non-US patent reference. The IDS manager 12 is capable of extracting citation metadata from the bibliographic information contained in the resource pointed to by the link.

The Non-Patent Literature References input box 54 is designed to receive complete or incomplete bibliographic data or a link for each non-patent literature reference to be cited in the electronic IDS to be produced by the IDS manager. Each non-patent literature document may correspond to any type of published document including, but not limited to, books, journal articles, theses, white papers, technical reports, presentation slides, advertisements, brochures, and web pages. The bibliographic data for each non-patent literature may be specified in one or more formats that can be parsed by the IDS manager 12. For example, the bibliographic data for books and journal articles may be specified in a variety of different standard formats including, but not limited to the APA style format, the IEEE style format, the MLA style format, the Chicago style format, and the Turabian style format. Each link entered into the Non-Patent Literature References input box 54 typically corresponds to a URL or a URI that identifying a web page or other resource that contains bibliographic information for a respective non-patent literature reference. The IDS manager 12 is capable of extracting citation metadata from the bibliographic information contained in the resource pointed to by the link.

The Files to be Submitted input box 56 is designed to receive a link (e.g., a URL or URI) to the storage location of a respective electronic reference to be cited in the electronic IDS. The references may be stored physically in a local database 58 of the client node 14 or in one or more remote databases 60, 62 that may be accessed over a local area network 64 and the wide area network 16, respectively (see FIG. 1). The references in the remote database 62 may be provided by a service provider free-of-charge or in exchange for a per-item fee or a subscription fee. Some references also may be stored in a remote database that is accessible over a peer-to-peer (P2P) network connection. The user may select a Browse button 66 to search for the links to the reference to be submitted. The user also is presented with a Category input box 68 that is designed to receive a specification of the type of reference being submitted (e.g., US patent reference, non-US patent reference, or non-patent literature reference). The Category input box 68 typically is implemented by one of a dropdown list box, a text box, and a combo text/dropdown list box. In response to the selection of an Add File button 70, the IDS manager 12 creates another input box for receiving a link to the storage location of another electronic reference to be cited in the electronic IDS, along with an associated Category input box.

The user may reset the IDS request submission page at any time by selecting a Reset button 74.

After completion of the IDS request, the user may select a Send button 72 to transmit the IDS request to the IDS manager. Prior to transmission, the elements of the IDS request are assembled by the web browser 18 or other computer program into a transmission package. In addition to the information entered into the input boxes 50-56, the transmission package includes information that labels each of the US patent publication numbers or links entered in the US Patent References input box 50 as US patent bibliographic record data, labels each of the non-US patent publication numbers or links entered in the non-US Patent References input box 52 as non-US patent bibliographic record data, labels each set of bibliographic data and each link entered in the Non-Patent Literature References input box 54 as non-patent literature bibliographic record data, and labels each of the links entered into the Files to be Submitted input box 56 as bibliographic record data of a type corresponding to the category entered into the associated category input box 68.

B. Producing an Information Disclosure Statement

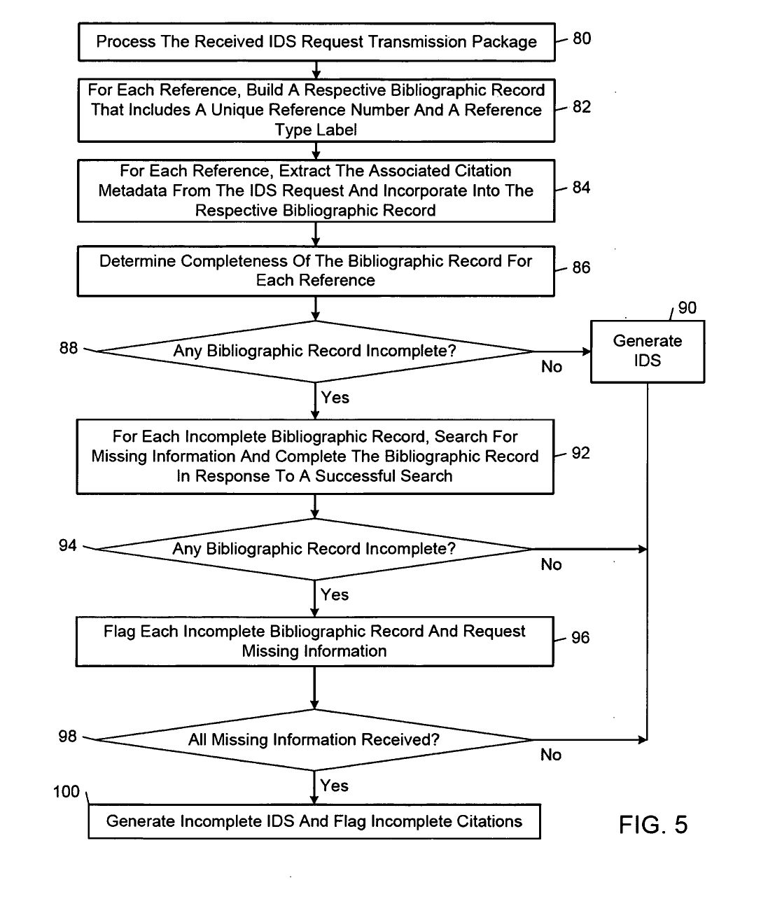

FIG. 5 shows an embodiment of a method that is implemented by some embodiments of the IDS manager 12 in response to receipt of an IDS request transmission package from the client node 14.

The IDS manager 12 processes the IDS request transmission package (FIG. 5, block 80). In some embodiments, the IDS manager 12 decrypts the transmission package and unpacks the IDS request (see FIG. 2, block 30). In some embodiments, the IDS manager 12 transmits to the user a confirmation page that contains a list of each of the references identified in the IDS request. In these embodiments, the user is asked to confirm the completeness of the list before the IDS manager 12 proceeds with the preparation of the electronic IDS.

For each of the references identified in the IDS request, the IDS manager 12 builds a respective bibliographic record that includes a unique reference number and a reference type label (FIG. 5, block 82). The reference number is used to index the bibliographic record. The reference type label corresponds to the label associated with the information used to identify the reference in the transmission package. For example, if the reference identifying information is labeled as US patent bibliographic record data in the transmission package, the reference type label in the bibliographic record corresponds to a US patent reference. If the reference identifying information is labeled as non-US patent bibliographic record data in the transmission package, the reference type label in the bibliographic record corresponds to a non-US patent reference. If the reference identifying information is labeled as non-patent literature bibliographic record data in the transmission package, the reference type label in the bibliographic record corresponds to a non-patent literature reference.

For each of the identified references, the IDS manager 12 extracts the associated citation metadata from the IDS request and incorporates the extracted citation metadata into the respective bibliographic record (FIG. 5, block 84). In this process, the IDS manager 12 determines the required citation metadata based on the reference type label that is associated with the reference. Each reference type label typically is mapped to a respective set of required citation metadata. This mapping typically is stored in a lookup table or other data structure on the IDS server node 12; although, in some embodiments, the mapping is stored on one or more remote nodes. The IDS manager 12 uses the reference type label associated with each reference as an index into the lookup table to determine the set of citation metadata that is required for that reference. In some embodiments, the lookup table includes a mapping between reference type labels and sets of citation metadata that meets the citation requirements that are specified by the USPTO. In these embodiments, the lookup table includes the following mapping between reference type labels and sets of required citation metadata:

| REFERENCE TYPE | REQUIRED CITATION METADATA |
|---|---|
| US Patent | Patent No.; Issue Date; Name of Patentee or |
| | Applicant |
| US Patent | Publication No.; Publication Date; Name of |
| Application | Patentee or Applicant |
| Publication | |
| Non-US Patent | Foreign Document No.; Country Code; |
| Reference | Publication Date; Name of Patentee or Applicant |
| Non-Patent | Name of the author, title of the article (when |
| Literature | appropriate), title of the item (book, magazine, |
| Reference | journal, serial, symposium, catalog, etc), date, |
| | pages(s), volume-issue number(s), publisher, city |
| | and/or country where published |

In Table 1, the Country Code corresponds to a two-letter code specified in the WIPO Standard ST.3 (see WIPO Handbook on Industrial Property Information and Documentation, Standard ST.3, World Intellectual Property Organization (April 2007)).

After extracting the citation metadata from the IDS request (FIG. 5, block 84), the IDS manager 12 determines the completeness of the bibliographic record for each reference (FIG. 5, block 86). In this process, the IDS manager 12 determines whether citation metadata was extracted for each of the required citation metadata types. If less than all of the required citation metadata types were extracted for a given bibliographic record, that bibliographic record is designated as an incomplete bibliographic record.

If none of the bibliographic records is incomplete (FIG. 5, block 88), the IDS manager 12 generates an electronic IDS from the bibliographic records (see FIG. 5, block 90). In this process, the IDS manager 12 inputs data from complete ones of the bibliographic records into matching fields of an electronic IDS form (e.g., USPTO form PTO/SB/08a) that contains fields for all of the information required for a valid citation of each of the references. The resulting electronic IDS contains a complete citation to each of the references.

For each of the bibliographic records determined to be incomplete (FIG. 5, block 88), the IDS manager 12 searches for missing information and completes the bibliographic record in response to a successful search (FIG. 5, block 92). As explained above (see FIG. 2, block 36), the IDS manager 12 may, for example, retrieve missing citation metadata (i) by submitting search queries to one or more of the search engines 20 and analyzing the search results or (ii) by accessing documents (e.g., web pages) or other resources pointed to by reference information identifying links that are extracted from the IDS request. In some embodiments, for each of the bibliographic records determined to be incomplete, the IDS manager 12 generates a citation search query, transmits the citation search query to at least one of the search engines 22, and receives a respective search response from the search engine. The IDS manager 12 typically generates the citation search query by extracts one or more search criteria (e.g., author and title of a journal article) from the bibliographic record. In response to a successful search, the IDS manager 12 extracts the missing citation metadata from the respective search response received from the search engine and uses the extracted citation metadata to complete the respective bibliographic record.

If, after searching for missing information, none of the bibliographic records is incomplete (FIG. 5, block 94), the IDS manager 12 generates an electronic IDS from the bibliographic records (see FIG. 5, block 90). The resulting electronic IDS contains a complete citation to each of the references.

If, after searching for missing information, any of the bibliographic records is determined to be incomplete, the IDS manager 12 flags each incomplete bibliographic record and transmits a request for additional information (FIG. 5, block 96). In this process, the IDS manager 12 requests additional information (e.g., the information that is missing from the bibliographic record or information that indirectly can be used to determine the missing information) from the client node 14 or from a remote service provider node (e.g., a remote service provider node providing specialized document search services). If all of the missing information is received from the client node 14 or the remote service provider node (FIG. 5, block 98), the IDS manager 12 generates an electronic IDS from the bibliographic records (see FIG. 5, block 90). If some of the missing information is not received (FIG. 5, block 98), the IDS manager 12 generates an incomplete electronic IDS that includes incomplete citations to the references for which complete bibliographic records were not built, along with flags demarcating the incomplete citations (FIG. 5, block 100). The flags typically are included in a separate document (e.g., an electronic mail message) that accompanies the electronic IDS that is transmitted to the user.

C. System Architecture

Embodiments of the IDS manager 12 may be implemented by one or more discrete modules (or data processing components) that are not limited to any particular hardware, firmware, or software configuration. In the illustrated embodiments, the modules may be implemented in any computing or data processing environment, including in digital electronic circuitry (e.g., an application-specific integrated circuit, such as a digital signal processor (DSP)) or in computer hardware, firmware, device driver, or software.

In some implementations, process instructions (e.g., machine-readable code, such as computer software) for implementing the methods that are executed by the embodiments of the IDS manager 12, as well as the data it generates, are stored in one or more machine-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

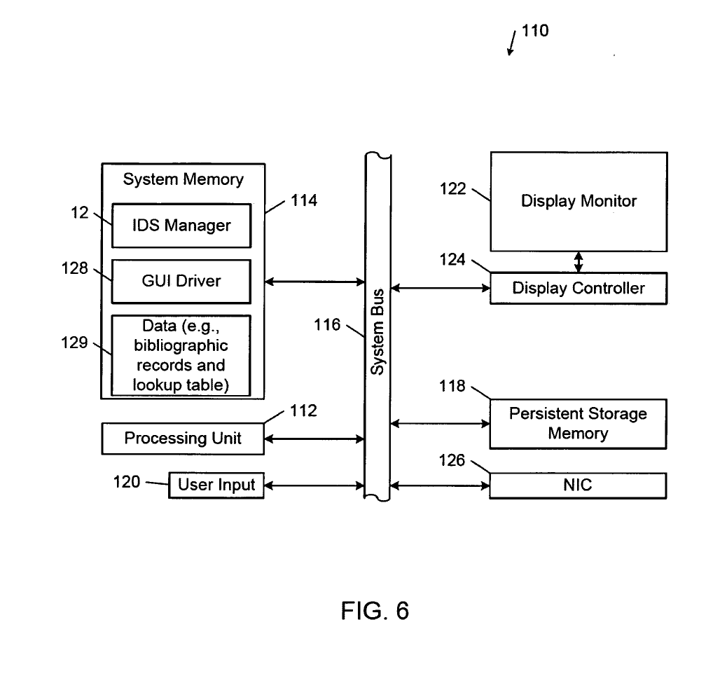

Referring to FIG. 6, in one embodiment, the IDS manager 12 may be implemented as one or more respective software modules operating on a computer 110. Computer 110 includes a processing unit 112, a system memory 114, and a system bus 116 that couples processing unit 112 to the various components of computer 110. Processing unit 112 may include one or more processors, each of which may be in the form of any one of various commercially available processors. System memory 34 may include a read-only memory (ROM) that stores a basic input/output system (BIOS) containing start-up routines for computer 110 and a random access memory (RAM). System bus 116 may be a memory bus, a peripheral bus or a local bus, and may be compatible with any of a variety of bus protocols, including PCI, VESA, Microchannel, ISA, and EISA. Computer 110 also includes a persistent storage memory 118 (e.g., a hard drive, a floppy drive, a CD ROM drive, magnetic tape drives, flash memory devices, and digital video disks) that is connected to system bus 116 and contains one or more computer-readable media disks that provide non-volatile or persistent storage for data, data structures and computer-executable instructions. A user may interact (e.g., enter commands or data) with computer 110 using one or more input devices 120 (e.g., a keyboard, a computer mouse, a microphone, joystick, and touch pad). The IDS manager 12 presents information to and receives information from a user through a graphical user interface (GUI) that is displayed to the user on a display monitor 122, which is controlled by a display controller 124. Computer 110 also may include peripheral output devices, such as speakers and a printer. One or more remote computers may be connected to computer 110 through a network interface card (NIC) 126.

As shown in FIG. 6, system memory 114 also stores the IDS manager 12, a GUI driver 128, and data 129 that includes the bibliographic data records and the lookup table mapping reference types to required citation metadata. The data 129 may be stored locally in persistent storage memory 118 or stored remotely and accessed through NIC 126, or both. The bibliographic records may be stored, for example, in an XML (eXtensible Markup Language) file format. The IDS manager 12 interfaces with the GUI driver 128 and the user input 120 to respond to user commands and selections. The IDS manager 12 also interfaces with the GUI driver 128 and the bibliographic data records to present requests for missing citation information on the display monitor 122.

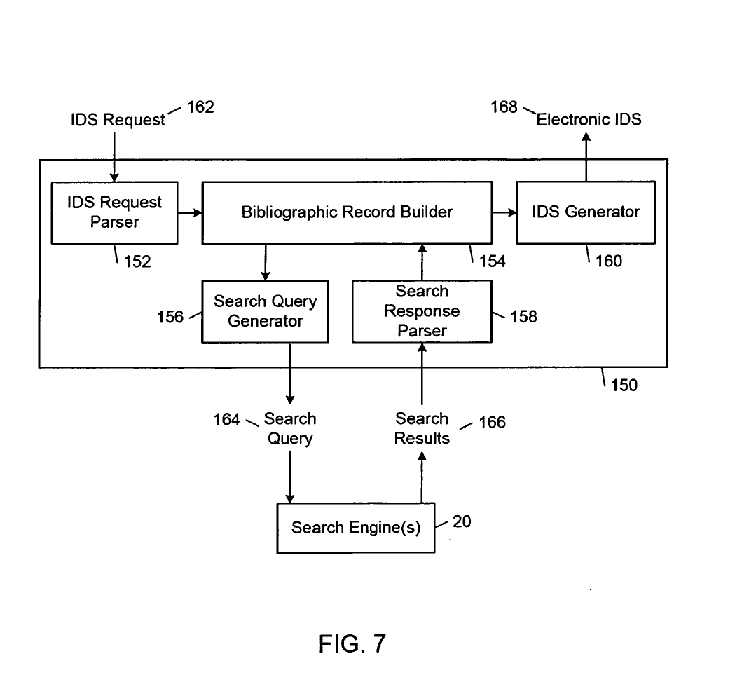

FIG. 7 shows an embodiment 150 of the IDS manager 12 that includes the following modules: an IDS request parser 152, a bibliographic record builder 154, a search query generator 156, a search response parser 158, and an IDS generator 160.

The IDS request parser 152 processes the received IDS request transmission package 162. In this process, the IDS request parser 152 decrypts the transmission package, unpacks the IDS request, and extracts reference identifying information from the IDS request. The IDS request parser 152 passes the extracted reference identifying information to the bibliographic record builder 154.

The bibliographic record builder 154 builds a respective bibliographic record for each of the references identified in the IDS request. In this process, the bibliographic record builder 154 passes incomplete bibliographic records to the search query generator 156.

The search query generator 156 generates a search query 164 for each of the bibliographic records determined to be incomplete by extracting one or more search criteria of the citation search from each of the bibliographic records. In this process, the search query generator 156 typically obtains from the bibliographic record at least one keyword that is used in the creation of the citation search query. The search query generator 156 typically translates the citation search query into a native format of each search engine before transmitting the citation search query to the search engine.

The search response parser 158 parses the search results 166 received from the search engines 20. In response to a successful search, the search response parser 158 extracts the missing citation metadata from the respective search response received from the search engine and passes the extracted citation metadata to the bibliographic record builder 154, which completes the respective bibliographic records.

The bibliographic record builder 154 passes the complete bibliographic records to the IDS generator 160, which generates an electronic IDS 168 from the bibliographic records.

In other embodiments, the functionalities of two or more of the modules 152-160 of the IDS manager 150 are combined into a single data processing component, or the respective functionalities of each of one or more of the modules 152-160 are performed by a respective set of multiple data processing components.

### V. A Second Exemplary Embodiment of the IDS Manager

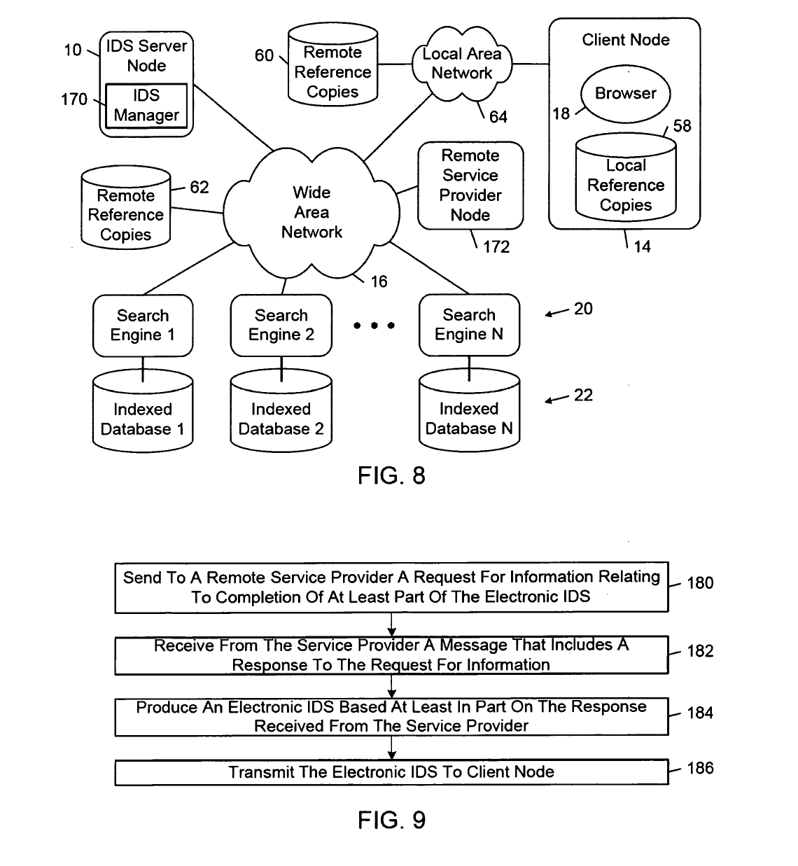

FIG. 8 shows an embodiment 170 of the IDS manager 12 that is connected to at least one remote service provider operating at a respective remote service provider node 172. In some embodiments, each of the remote service providers performs one or more of the electronic IDS preparation tasks described above, including building a respective bibliographic record for each of the references identified in the IDS request, determining incomplete ones of the bibliographic records, searching for missing bibliographic information, completing bibliographic records in response to successful searches, and producing electronic IDSs. In some embodiments, each of the remote service providers provides specialized document search services. For example, in some embodiments, at least one of the remote service providers performs customized manual and/or automated searches for information needed to complete bibliographic records, which were not completed after the initial round of searching for missing information. In some embodiments, the remote service provider is a third party service provider. In other embodiments, the remote service provider is affiliated with the owner or controller of the IDS manager 170.

FIG. 9 shows an embodiment of a method that is implemented by embodiments of the IDS manager 170. In accordance with this embodiment, after receiving an IDS request from the client node 14, the IDS manager 170 sends to the remote service provider node 172 a request for information relating to the completion of at least part of an electronic IDS (FIG. 9, block 180). The request may range from a request for information missing from one or more bibliographic records to a request for the production of the electronic IDS in its entirety. The IDS manager 170 receives from the remote service provider node 172 a message that includes a response to the request for information (FIG. 9, block 182). The IDS manager 170 produces an electronic IDS based at least in part on the response received from the remote service provider node (FIG. 9, block 184). In this process, the IDS manager 170 may complete a previously incomplete IDS or it may modify an IDS received from the remote service provider node 172 to include additional information (e.g., information, such as a matter number or a patent application number, which identifies the IDS to the user). The IDS manager 170 transmits the electronic IDS to the client node 14 (FIG. 9, block 186).

In some embodiments, the IDS manager 170 assigns to each IDS request a respective IDS session identifier that uniquely identifies the IDS request. In some embodiments, each IDS session identifier is a character string generated by a pseudorandom character string generator. The IDS session identifier is used by the IDS manger 170 to create a respective validation token for communications with each of the remote service providers. The validation tokens are used to secure and authenticate messages that are exchanged with respective ones of the remote service providers. In some embodiments, the IDS manager 170 creates the validation token by concatenating the session identifier with a respective unique service provider identifier that the IDS manager 12 has assigned to each of the remote service providers. If the session identifier is encrypted, it may be transmitted to the remote service provider over both encrypted and unencrypted communications channels. If the session identifier is unencrypted, it typically is transmitted to the remote service provider over an encrypted communications channel.

In some embodiments, each remote service provider places the respective validation token into each message that is sent to the IDS manager 170. Before sending a respective message to the IDS manager 170, each remote service provider signs the message using a private key that matches a public key certificate that the remote service provider previously gave to the IDS manager 170. The IDS manager 170 validates each message and the validation token embedded in the message. In this process, the IDS manager 170 validates the message using the remote service provider's public key. The IDS manager extracts the validation token from the decrypted message and validates the validation token by ensuring that it was not modified and corresponds to the validation token that was issued to the remote service provider. If the message and the validation token are valid, the IDS manager 170 uses the validation token to determine the session identifier that was assigned to IDS request, which is the subject of the message received from the remote service provider. The IDS manager 170 uses the session identifier to retrieve the data (e.g., the bibliographic records and/or a partially completed IDS form) that is associated with the IDS request identified by the session identifier.

In these embodiments, the IDS manager 170 incorporates the IDS session identifier into messages that are sent from the IDS server node 18 to the remote service provider node 172, and the remote service provider node 172 is required to incorporate the IDS session identifier into the messages that are sent from the remote service provider node to the IDS server node 18. The IDS manager 170 matches the information received from the remote service provider node to the IDS request based on the IDS session identifier in the message received from the remote service provider node. In this way, the IDS manager 170 may incorporate the information received from the remote service provider node 172 into the electronic IDS that is sent to the client node 14.

In these embodiments, the client and its data can remain anonymous to each of the remote service providers because the validation tokens do not reveal the client's identity. In addition, since each remote service provider is assigned a different validation token for each IDS request, it is very difficult for different remote service providers to correlate their data sets to the same IDS request, even if they can share different sets of data relating to the IDS requests.

In some embodiments, the IDS manager 170 performs the unpacking (FIG. 2, block 30), the building (FIG. 2, block 32), the determining (FIG. 2, block 34), the searching (FIG. 2, block 36), the completing (FIG. 2, block 36), and the producing (FIG. 2, block 26). In the course of searching, however, the IDS manager 170 transmits to the remote service provider node a message containing a request for information relating to completion of at least part of the electronic IDS (e.g., the information that is missing from the bibliographic record, or information, such as a pointer to a document or other resource, which indirectly can be used to determine the missing information). In these embodiments, the remote service provider node 172 sends to the IDS manager 170 a message that includes a response to the request for information. After receiving the response from the remote service provider node 172, the IDS manager modifies the electronic IDS based on the information contained in the response and transmits the modified electronic IDS to the user at the client node 14.

### VI. Conclusion

The embodiments that are described herein provide systems and methods of producing information disclosure statements (IDSs). These embodiments are designed to alleviate the tedious, time-consuming, laborious, and error-prone task of manually preparing such IDSs. In addition, these embodiments are capable of automatically handling the retrieval of missing citation metadata, alleviating the substantial burden that oftentimes is associated with manual retrieval of such information.

Other embodiments are within the scope of the claims.

What is claimed is:

1. A machine-implemented method, comprising:
unpacking an information disclosure statement (IDS) request comprising information identifying one or more references;
for each of the references, building a respective bibliographic record from the information in the IDS request;
determining incomplete ones of the bibliographic records;
for each of the bibliographic records determined to be incomplete, searching for information needed to complete the bibliographic record and completing the bibliographic record in response to a successful search; and
producing an electronic IDS from one or more of the bibliographic records.

2. The method of claim 1, wherein the unpacking comprises extracting citation metadata from the information in the IDS request.

3. The method of claim 2, wherein the IDS request comprises text identifying at least one of the references, and the unpacking comprises extracting citation metadata from the text contained in the IDS request.

4. The method of claim 2, wherein the IDS request comprises a respective one of the references, and the unpacking comprises extracting citation metadata from the respective reference.

5. The method of claim 2, wherein the determining comprises for each of the references: determining a respective reference type; selecting a respective set of citation metadata types required for a complete citation to the determined reference type; and determining whether citation metadata was extracted for each of the required citation metadata types.

6. The method of claim 1, wherein the searching comprises for each of the bibliographic records determined to be incomplete: generating a citation search query from the bibliographic record; transmitting the citation search query to at least one web search engine; and receiving a respective search result from the web search engine.

7. The method of claim 6, wherein for each of the bibliographic records determined to be incomplete the generating comprises extracting one or more search criteria of the citation search from the bibliographic record.

8. The method of claim 6, wherein for each of the bibliographic records determined to be incomplete the extracting comprises obtaining at least one keyword from the bibliographic record.

9. The method of claim 6, wherein for each of the bibliographic records determined to be incomplete the completing comprises extracting missing citation meta data from the respective search result received from the web search engine.

10. The method of claim 1, wherein the producing comprises inputting citation metadata extracted from complete ones of the bibliographic records into matching fields of an electronic IDS form.

11. The method of claim 1, further comprising receiving the IDS request at an IDS server node from a client operating at a remote client node.

12. The method of claim 11, wherein the unpacking, the determining, the building, the searching, the completing, and the producing are performed at the IDS server node, and further comprising transmitting the electronic IDS from the IDS server node to the client node.

13. The method of claim 11, wherein the unpacking is performed at the IDS server node, and further comprising sending a message comprising a request for information relating to completion of at least part of the electronic IDS from the IDS server node to a service provider operating at a remote service provider node and, at the IDS server node, receiving from the service provider a message comprising a response to the request for information.

14. The method of claim 13, further comprising, at the IDS server node, receiving information relating to the electronic IDS in the response from the service provider and producing the electronic IDS based on the received information before transmitting the electronic IDS to the client node.

15. The method of claim 13, further comprising assigning to the IDS request a respective IDS request identifier that uniquely identifies the IDS request without identifying the client to the service provider.

16. The method of claim 15, wherein the message sent from the IDS server node to the service provider comprises the IDS request identifier and the message received from the service provider comprises the IDS request identifier.

17. The method of claim 15, further comprising, at the IDS server node, matching the response received from the service provider to information relating to the IDS request based on the IDS request identifier in the message received from the service provider.

18. The method of claim 1, further comprising generating a graphical user interface allowing a user to specify the IDS request and comprising at least one input box capable of receiving information identifying at least one of the references.

19. The method of claim 18, wherein the graphical user interface comprises a US patent reference input box, a non-US patent reference input box, and a non-patent literature reference input box, and further comprising labeling bibliographic data input into the US patent reference input box as US patent bibliographic record data, labeling bibliographic data input into the non-US patent reference input box as non-US patent bibliographic record data, and labeling bibliographic data input into the non-patent literature reference input box as non-patent literature bibliographic record data.

20. The method of claim 18, wherein the graphical user interface comprises at least one input box capable of receiving one or more pointers to respective ones of the references.

21. Apparatus, comprising:
a memory; and
a processing unit coupled to the memory and operable to perform operations comprising
unpacking an information disclosure statement (IDS) request comprising information identifying one or more references;
for each of the references, building a respective bibliographic record from the information in the IDS request;
determining incomplete ones of the bibliographic records;
for each of the bibliographic records determined to be incomplete, searching for information needed to complete the bibliographic record and completing the bibliographic record in response to a successful search; and
producing an electronic IDS from one or more of the bibliographic records.

22. A machine readable medium storing machine-readable instructions causing a machine to perform operations comprising:
unpacking an information disclosure statement (IDS) request comprising information identifying one or more references;
for each of the references, building a respective bibliographic record from the information in the IDS request;
determining incomplete ones of the bibliographic records;
for each of the bibliographic records determined to be incomplete, searching for information needed to complete the bibliographic record and completing the bibliographic record in response to a successful search; and
producing an electronic IDS from one or more of the bibliographic records.
